(19) United States
(12) Patent Application Publication
(10) Pub. No.: US 2010/0307596 A1
(43) Pub. Date: Dec. 9, 2010

(54) LIQUID APPARATUS

(76) Inventor: Geoffrey Neil McConnell, Christchurch (NZ)

Correspondence Address: SNR DENTON US LLP, P.O. BOX 061080, CHICAGO, IL, 60606-1080, US

(21) Appl. No.: 12/440,236

(22) PCT Filed: Sep. 6, 2007
(86) PCT No.: PCT/NZ2007/000259

§ 371 Date: Aug. 24, 2010

(30) Foreign Application Priority Data
Sep. 6, 2006 (NZ) 549706

(51) Int. Cl. F15D 1/00; G01F 23/72; B66F 3/25

(52) U.S. Cl. 137/1; 73/309; 137/386; 254/93 R

(57) ABSTRACT

The present invention provides a liquid apparatus (1) with a housing (2) with a liquid conduit (3) therethrough and at least one moveable element (4) slideably coupled to the housing (2) via at least one coupling (5). The coupling (5) includes at least one pair of mutually magnetically interactive portions (6, 7), one portion (6) located as at least part of the moveable element (4), the other portion (7) at least partially formed as a buoyancy float (8) in the liquid conduit (3), wherein slideable movement of the moveable element (4) produces a corresponding movement of the coupling portion (5) within the housing (2) and in use the position of the buoyancy float (8) is variable by adjusting the total mass of the moveable element (4).

### CROSS REFERENCE TO OTHER APPLICATIONS

This is a National Phase of International Application No. PCT/NZ2007/000259 filed on Sep. 6, 2007, which claims priority from New Zealand Patent Application No. 549706, filed on Sep. 6, 2006, which is based on the Provisional specification filed in relation to New Zealand Patent Application Number 549706, the entire contents of which are incorporated herein by reference.

### TECHNICAL FIELD

The present invention relates to a decorative liquid apparatus, feature or display, particularly a water feature with moveable elements to provide an aesthetic visual effect.

### BACKGROUND ART

Water displays, features, fountains and the like are becoming increasingly prevalent in domestic, public and commercial settings including homes, offices, shopping malls, airports, public parks, and civic areas. Such water features range in size from diminutive table top designs to monumental fountains, each intended to provide an aesthetically pleasing visual and, in some instances, audible effect to aid human relaxation and environmental enjoyment.

To maximise the viewer's interest and enjoyment, it is desirable that the water display incorporates a degree of visual and or audible variation without adversely impacting the adjacent surround environment. As an exemplary illustration, waterfalls provide an attractive audible signature, though the accompanying splashing may fall outside the waterfall perimeter without a significant catchment footprint. Water falling outside the water feature catchment may damage adjacent furnishings or floor surfaces in both private and public applications in addition to posing safety concerns from accidental falls. It is thus desirable to constrain any falling water within a definable area without a deleterious effect on the water feature's aesthetics and, preferably, without removing the capacity for variation in the visual or auditory effect.

Moveable elements incorporated in the water feature provide a visual enhancement and may prolong a viewer's interest. However, there is consequentially an attendant need for motive means to drive and control the elements which adds complication, potential unreliability and cost and may be unsightly or inelegant. Thus, it is desirable to have a water feature whose moveable elements avoid the aforementioned disadvantages. It would be further desirable to allow user control over the element movement to engender an increased interest span and desire for involvement with the water feature.

It will be appreciated that such a decorative feature may, by virtue of its moveable elements, also provide further capabilities aside from its aesthetic benefit.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided a liquid apparatus including
a housing with a liquid conduit therethrough; and
at least one moveable element slideably coupled to said housing via at least one coupling;
said coupling including at least one pair of mutually magnetically interactive portions, one portion of said pair being located as at least part of said moveable element, the other portion of said pair at least partially formed as a buoyancy float in the liquid conduit, wherein slideable movement of said moveable element produces a corresponding movement of said coupling portion within said housing; and
characterised in that in use the position of the buoyancy float is variable by adjusting the total mass of at least one said movable element.

According to one embodiment, interaction between said portions of a pair of mutually magnetically interactive portions is by mutual magnetic attraction. In a further embodiment, interaction between said portions of a pair of mutually magnetically interactive portions is by mutual magnetic repulsion.

In the former embodiment, the magnetic attraction between the coupling portions may be configured in a variety of arrangements, including:
a permanent magnet in one portion and a ferrous material or any other material capable of experiencing a motive force from a magnetic field (hereinafter termed a ‘magnetic material) in the other portion,
either an electromagnet or permanent magnet in both portions with magnetic polarity orientated for the portions to be mutually attractive; or
an electromagnet in one portion and a magnetic material in the other portion.

In the latter embodiment, the magnetic repulsion between the coupling portions may also be configured in a variety of arrangements, including:
either an electromagnet or permanent magnet in both portions with magnetic polarity orientated for the portions to be mutually repulsive.

Preferably, in the latter embodiment, the apparatus is configured in use such that the portion of the coupling located in the moveable element is positioned at a higher elevation than the pair's corresponding portion in the housing. Using magnetic repulsion provides several advantageous facets from a safety and/or ergonomic perspective. The repulsive action of the coupling will attempt to force the movable element away from the coupling portion in the housing. Where the movable element is constrained to move substantially vertically for example and the movable element is initially positioned at an at least slightly higher elevation, an equilibrium position is reached where the repulsive magnetic forces are balanced by the opposing gravitational force acting on the movable element. As additional force is exerted on the movable element (e.g. by receiving/supporting additional fluid and/or a human user(s) the magnets are brought into closer proximity, thereby increasing the repulsive force providing a progressive breaking force on the movable element.

In comparison, if an attractive magnetic interaction is present between the portions of the coupling, the effect of increased downward force on the movable element would be to weaken the resultant force of magnetic attraction.

The invention shall henceforth be described with respect to an embodiment where said liquid is water, though it will be readily appreciated that myriad alternative liquids may be used as desired such as oil, wine, and so forth.

Preferably, said coupling portion within the housing is attached to, or formed as, a buoyancy float.

Preferably, said slideable movement has an at least partially vertical component. According to one embodiment, said slideable movement is substantial linear about a vertical axis. It will be readily appreciated that alternative housing configurations are possible in which movement of the float may be constrained to include a circuitous or partially lateral component as well as the vertical component.

According to another aspect of the present invention said housing includes a substantially vertical elongate tube with an inner and outer surface. In one embodiment the or each slideable element is located about said outer surface with said corresponding float located adjacent said inner surface.

Preferably, the inner tubular surface also defines said liquid conduit. Liquid present in the liquid conduit thus acts to urge the float vertically upwards. The movement of the float within the liquid conduit is governed by factors including:
the float's buoyancy (a function of its mass and volume) with respect to the density and viscosity,
the vertical height,
the upward thrust, and
the surface area and configuration of the lower float surface presented to the thrust,

of any liquid present (and moving) within the conduit, together with interaction with any physical constraints from the conduit, e.g. friction or engagement with any barriers or stops.

In use, the float is also coupled magnetically to its corresponding moveable element whose weight acts (via the coupling) downwards on the float. Thus, there are numerous means available to control the vertical height of the float by varying one or more of the above parameters.

Thus, according to a further aspect of the present invention, the vertical height of the float and moveable element coupled to the float is controlled by at least one of:
adjusting the vertical height of a column of liquid in the liquid conduit, such that the float and moveable element is maintained at the liquid column's upper surface;
adjusting the flow rate of liquid flowing through the liquid conduit;
adjusting the total mass of a moveable element.

According to one aspect of the invention, allowable movement of a float is vertically constrained by an upper and lower stop in the liquid conduit. The liquid conduit is filled with liquid and the float and moveable element rise to the upper stop. The moveable element mass is then increased by ingress of, and at least partial retention of, liquid until the combined liquid and moveable element mass exceeds the float buoyancy and the coupled float and moveable element descend. Discharging the retained liquid from the moveable element allows the float and moveable element to rise again and the cycle may be repeated.

In one embodiment, said ingress of liquid into the moveable element is provided by liquid overflow from the liquid conduit. Alternatively, said ingress may be supplied from an external liquid supply.

Preferably, said liquid feature display further includes a liquid supply, pump and liquid flow control system. The liquid may be pumped into the liquid conduit (raising each float between its lower and upper stops) until liquid overflows from an outlet in the liquid conduit into the or each moveable element. The liquid conduit outlet may be placed at any convenient position, e.g. at the uppermost point, or located in the lateral portions of the housing above the uppermost stop of the uppermost moveable element. The liquid flow control system may be comprised of a variety of known means capable of regulating and/or varying the liquid flow rate, and may be formed integrally with the pump, or as a discrete unit interfaced with the pump, or operate as a standalone unit.

The liquid flow control system may also incorporate user control, whereby pedestrians may control the movement of the moveable elements by varying the liquid flow rate as discussed above. Thus, the involvement of the viewer's interest generated by the gentle rise and fall of the moveable elements is further enhanced by the ability for user control over the element's movements.

It will be appreciated that in an embodiment with a plurality of moveable elements, e.g. a vertical column with the elements vertical spaced apart between their respective upper and lower stops, the overflowing liquid exiting the housing above the uppermost element may be configured to flow successively into the adjacent element below. This cascading effect causes the elements to move in a consequential, though not simultaneous manner to further enhance the viewer's interest.

The moveable elements may be formed in a wide variety of configurations, such as annular dish shapes with curved, circular, polygonal, asymmetrical, continuous or segmented portions and the like formed with a liquid detention portion capable of receiving, and at least temporarily retaining, liquid.

Preferably, the or each moveable elements include liquid drain apertures, positioned to allow the egress of liquid collected in said liquid detention portion. In one embodiment, said drain apertures are reversibly sealable. Thus, the drain apertures may be unsealed or ‘opened’ by some form of trigger, either remotely (e.g. electronically controlled valves) or automatically e.g. by contact of the element with the lower stop. In embodiments with fixed, unsealed drain apertures, when the moveable element is in an upper position (e.g. resting against the upper stop), the element vertical position may be lowered by the liquid flow controller setting a flow rate sufficient to cause the ingress of liquid into an element's detention portion (either received as overflow from the housing liquid conduit or from an external liquid supply controlled by the liquid flow controller) to exceed the drainage rate from the drain apertures. Thus, the detention portion fills with liquid, the mass of the element increases and eventually the element descends. Reducing the detention portion ingress rate below the drainage rate results in a net egress of liquid from the element and eventually the element rises.

It will also evident to one skilled in the art that the cascading liquid flow between elements need not necessarily be located on the same housing. A plurality of housings may be spatially disposed such that their respective moveable elements interleave to allow liquid to interact between the separate housings. Endless combinations of overflowing liquid interacting between moveable elements on different housings are possible creating endless variations in visual effect.

It will be appreciated that further liquid sources may be used to supplement or even replace the liquid flow through the housing liquid conduit. This may take the form of an external fixed waterfall or jet configured to deliver liquid to the uppermost moveable element. Control of the liquid flow for such a static external liquid supply may be automated and/or incorporate user control via the liquid flow control system as previously described. To add a further aspect of user enjoyment, particularly in venues such as aquatic centres and swimming pools, water cannons (i.e. moveable external water jets) may be aimed by the user to fill the moveable elements. Where the external liquid supply is used as the sole means of controlling the position of the moveable elements, the housing containing the associated floats may be essentially sealed with liquid filling the liquid conduit.

The present invention may also incorporate numerous further features including, but not limited to,
magnetic buffers replacing, or supplementing the upper and lower stops. By appropriate use of a repelling polarity magnet, magnetic buffers may provide a cushioned deceleration of the moveable element at the limits of its allowable vertical travel;
supplementary, or alternative motive means to raise and lower the moveable elements (acting on the float, moveable element or both), including electromagnetic induction, pulleys, electrical, hydraulic, pneumatic and other mechanical and electromechanical drives.
Although such drive means add complication, and potential unsightliness, the mechanisms may be concealed within the housing leaving the moveable elements visually free of any apparent drive means.
the housing, float and/or the moveable element may be formed as translucent, transparent or opaque to give differing visual effects. Moreover, non-opaque construction enables the incorporation of internal lighting in addition to external lighting for yet further visual enhancements.

A markedly differing visual effect may be achieved in an alternative embodiment (albeit operationally, and conceptually coterminous with the above described embodiments) in which the or each float is located adjacent said outer surface of a housing portion with the corresponding float located adjacent said inner surface. Thus, the liquid feature display is essentially configured in the converse arrangement whereby liquid surrounds an elongate tubular housing portion with one or more moveable elements positioned in a liquid void inside, rather than outside the housing portion. The float and coupling, corresponding to each moveable element still operate in a directly comparable manner as described in previous embodiments. In such embodiments, the body of liquid in the liquid conduit about the elongate tubular inner ‘cores’ may be constrained by further housing portions formed by the walls of a tank or pool, e.g., fish tanks, aquariums or the like.

In large scale embodiments with a capacity to raise moveable elements of an appreciable total mass, the feature may even be used as a form of novelty lift to transport individuals. The liquid flow control may thus be configured to be operable from the moveable element itself allowing the user to cause the element to rise and fall.

The present invention thus provides a visually and audibly variable liquid display without the encumbrances of complex or unsightly control mechanisms, or excessive splashing, which may be scaled to suit a wide variety of locations.

### BRIEF DESCRIPTION OF DRAWINGS

Further aspects of the present invention will become apparent from the following description which is given by way of example only and with reference to the accompanying drawings in which:

FIG. 1 shows a schematic side elevation section of a preferred embodiment of the present invention;

FIG. 2 shows a side elevation of a further embodiment including a plurality of liquid feature housings, and

FIGS. 3a, b) shows a side elevation of a further embodiment in an upper and lower loading/unloading position.

### BEST MODES FOR CARRYING OUT THE INVENTION

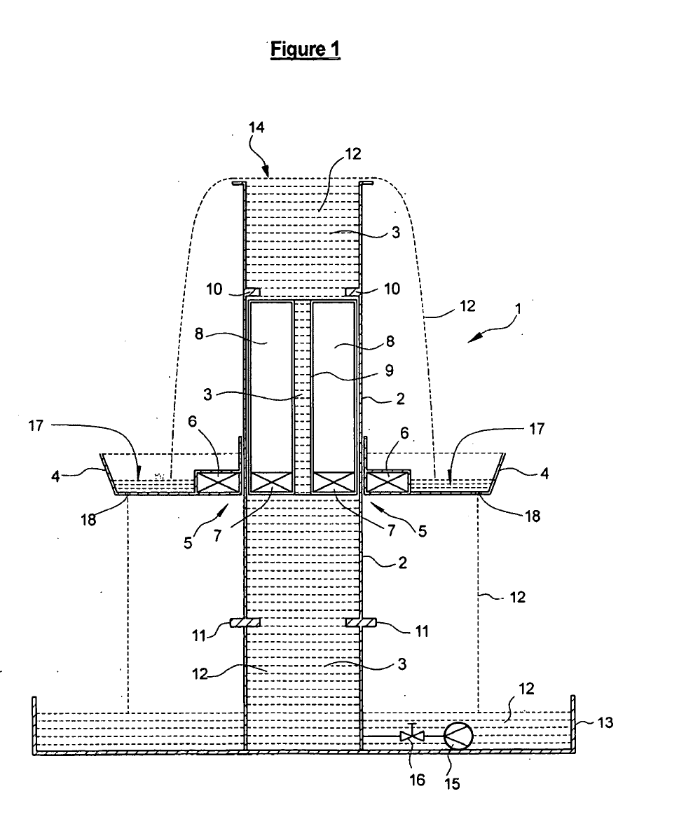

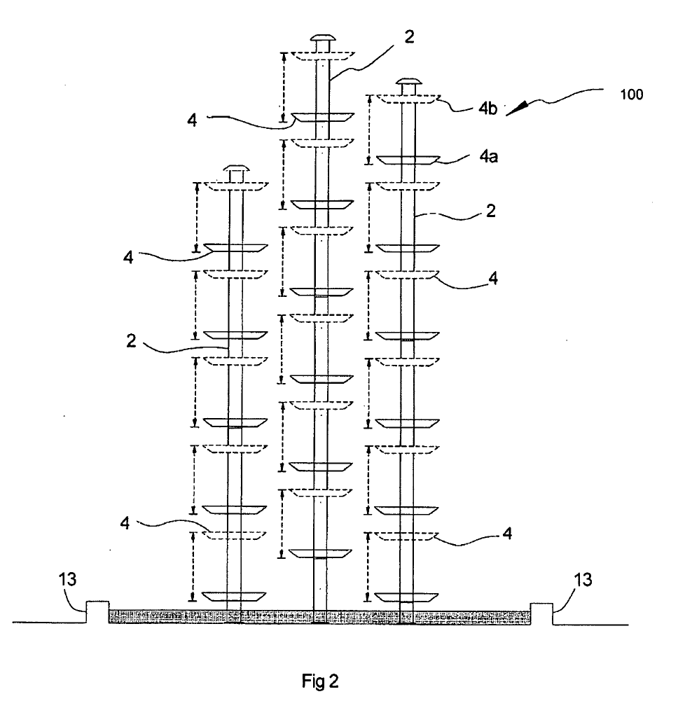

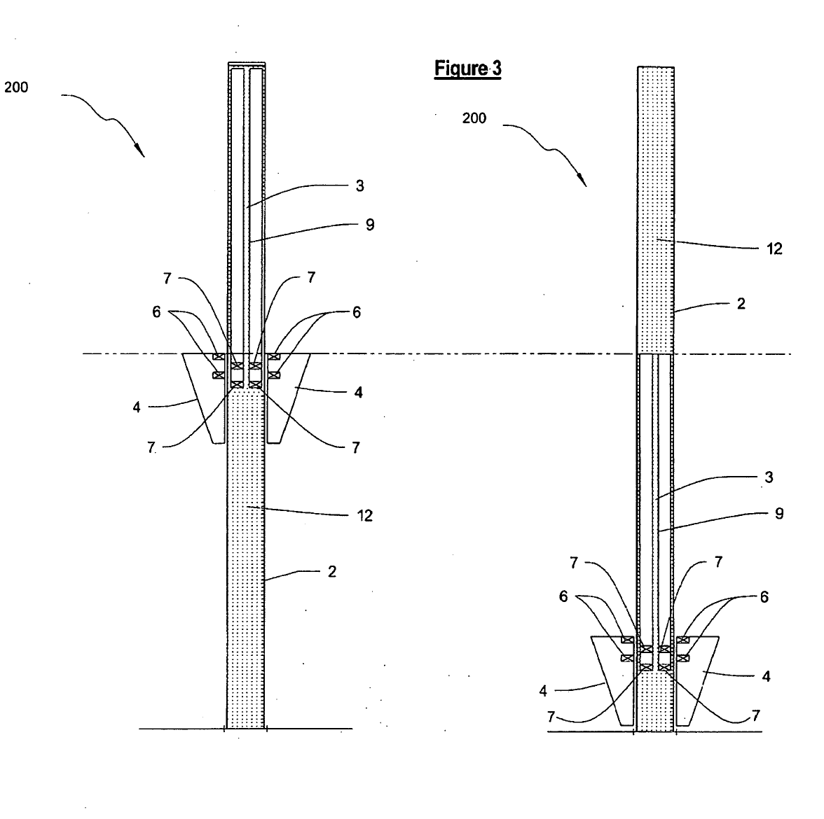

The figures show preferred embodiments of the present invention a liquid apparatus in the form of a decorative water feature (1) comprised generally of a housing (2) with an internal liquid conduit (3) and at least one moveable element (4) shown in the form of an annular dish-shaped receptacle. FIG. 1 shows an exemplary embodiment with a element (4), whilst FIG. 2 shows a liquid feature assembly (100) including a plurality of decorative water features (1) providing three cylindrical tubular housings (2), each equipped with a plurality of annular elements (4) vertically spaced apart about the housing (2). FIG. 3 shows a liquid apparatus in the form of a lift (200) with components generally similar to the water feature (1) of FIG. 1, thus common components are referenced the same.

Each moveable element (4) is slideably coupled to the housing (2) via at least one coupling (5) comprised of a pair of mutually magnetically attractive portions (6, 7), an outer portion (6) of said pair being located in the moveable element (4) and the other portion (7) of the pair being located in the housing (2). There is no physical connection between the separate portions (6, 7) of the coupling (5), allowing both portions to slide vertically along the surface of the tubular housing (2).

The magnetic attraction between the coupling portions (6, 7) may be configured in a variety of arrangements, i.e.
a permanent magnet in one portion and a ferrous material or any other material capable of experiencing a motive force from a magnetic field (hereinafter termed a ‘magnetic material) in the other portion,
either an electromagnet or permanent magnet in both portions (6, 7) with magnetic polarity orientated for the portions to be mutually attractive; or
an electromagnet in one portion (6 or 7) and a magnetic material in the other portion (7 or 6).

The inner coupling (7) is attached to a buoyancy float (8), although in alternative embodiment, the coupling portion (7) and float (8) may be integrally formed as a single discrete unit. In the embodiment of FIG. 1, the float (8) is substantially cylindrical and incorporates a continuous central aperture (9), allowing liquid to pass through the float (8). The vertical movement of the float is constrained at an upper and lower position by an upper (10) and lower stop (11) respectively which project into the liquid conduit (3) from the inner walls of the housing (2). The lower stop (11) also projects outward from the external surface of the housing (2) to provide a lower stop for the moveable element (4).

In the preferred embodiment shown in FIGS. 1 and 2, liquid (12) (typically water) is pumped from a lower catchment pool (13) through the internal liquid conduit (3) in the housing (2), and exits as an overflow via an outlet (14) formed by the open upper end of the tubular housing (2) eventually re-entering the catchment pool (13) to be re-cycled. In alternative embodiments (not shown), the liquid may be continuously supplied via an external supply and exited to a separate waste rather than being re-cycled. A pump (15) provides the liquid (12) at sufficient pressure to reach the upper outlet (14) while a liquid flow control system, in the form of pump control valve (16) regulates the flow rate according an external programmer (not shown) and/or manual user intervention. Numerous alternative pump (15) and controller (16) configurations are possible as will be well known to one skilled in the art.

When liquid fills the liquid conduit (3), the float (8) and (via the coupling (5)) moveable element (4) rise from resting on the lower stop (11) vertically upwards until contacting the upper stop (10). This is repeated (as shown in FIG. 2) for each float/moveable element (8, 4) associated with the housing (2), where each moveable element (4) is shown with its permissible range of movement between the lower (4a) and upper (4b) positions.

In one embodiment, the rise and fall of the floats (8) may be controlled solely by varying the vertical height of liquid 12) within the tubular housing (2), optionally with liquid being expelled from the housing (2) directly into the catchment pool (13) to lower the floats (8). However, the sight of water falling outside the housing provides an attractive visual and audible signature for spectators.

Thus, in the preferred embodiment shown in FIG. 1, the liquid (12) overflowing from the housing outlet (14) falls into a moveable element (4) thereby increasing its mass. When combined weight of the moveable element (4) and the collected liquid (12) exceeds the buoyancy of the float (8), the moveable element/float assembly (4, 8) descends until reaching the lower stop (11). To allow the moveable element to rise again, the collected liquid (12) needs to be expelled and this may be achieved in a variety of means.

Although the moveable elements (4) may be formed in a wide variety of configurations, such as annular dish shape shown in FIGS. 1 and 2, each embodiment includes a liquid detention portion (17) capable of receiving, and temporarily retaining the overflow liquid (12) from the housing outlet (14). The detention portion (17) also includes, or is connected to, liquid drain apertures (18) positioned to allow the egress of liquid collected in said liquid detention portions (17). As will be readily apparent to one skilled in the art, varying the liquid flow rate will alter the rate of liquid (12) ingress to the detention portion (17). Given a fixed egress rate via the liquid drain apertures (18), such variations in the liquid flow rate dictate whether there is a net accumulation or decrease in liquid (12) in the moveable element (4). Thus, the liquid flow rate controller (16) may be used to control the movement of the moveable elements (4) by successively increasing and decreasing the flow rate to successively lower and raise the moveable elements.

In embodiments with multiple moveable elements (4) (as per FIG. 2), the liquid discharged from the drain apertures (18) of the uppermost moveable element (4) falls into the detention portion (17) of the moveable element (4) immediately below, which undergoes the same collection/discharge cycle with the attendant raising and lowering motion. Thus, the same liquid may be used to cascade between a succession of moveable elements (4) to give a pleasing aesthetic effect.

In an alternative embodiment (not shown), the drain apertures (17) may be reversibly, and selectively sealed. A constant liquid (12) flow may thus be provided by pump (15) to fill the respective detention portions (17) with liquid (12), while the drain apertures (18) are only selectively ‘opened’ at a specific point. The selective opening may be via remote actuation (e.g. using remotely-controlled electronic valves) or triggered automatically, e.g. by contact of the moveable element (4) with the lower stop.

In yet further embodiments, external liquid supply sources (not shown) may be used to supplement or even replace the liquid flow through the housing liquid conduit (3). Such external liquid (12) supply means may include fixed waterfalls located above the moveable elements (4) or liquid jets spraying a liquid in a trajectory from adjacent location to deliver liquid (12) to the uppermost moveable element. Moveable liquid jets used in aquatic centres and swimming pools, provide potential user enjoyment through the challenge of filling and moving the moveable elements (4).

In the embodiment shown in FIG. 3, the liquid apparatus (100) may be utilised as a ‘lift’ to transport objects and or users. Typically, such a lift operates in a substantially vertical orientation such as the embodiment shown in FIG. 3. The lift shown in FIG. 3 is a variant of a traditional ‘firemen's pole’ adapted to provide an amusement/recreational feature. It will however be readily evident to one skilled in the art that several further variants are possible without departing from the scope of the invention. FIG. 3a) shows an elongated housing (2) surrounded by an annular movable element (4) in the form of a lift car. A user (not shown) located at a first (upper) platform (19) is able to step onto an upper surface of the movable element (4) when positioned in its uppermost position. The additional weight of the user causes the movable element (4) to descend against the resistive force of the buoyancy of the float (8), magnetically coupled to the movable element (4). The rate of descent may be reduced by the user wrapping the arms and/or legs around the housing (2) to apply frictional restraint. When the movable element (4) reaches the bottom of its travel (as shown in FIG. 3b)), the user exits onto a second (lower) adjacent platform (20). The movable element (4) then ascends to the upper platform (19).

In contrast to the above-described embodiments, the coupling (5) of the embodiment shown in FIG. 3 comprises two pairs of magnets orientated such that the magnets (6) in the movable element (4) repel the magnets (7) located in the housing (2). The magnets (7) in the housing (2) are fitted to the float (8) and positioned slightly below the magnets (6) in the movable platform (4). Thus, the any increase in downward force on the movable element (4) (e.g. the addition of an object or person) would urge the magnets (6) into closer proximity with the magnets (7) in the float (8), which in turn would increase the repulsive force therebetween.

Aspects of the present invention have been described by way of example only and it should be appreciated that modifications and additions may be made thereto without departing from the scope thereof.

1. A liquid apparatus including:
a housing with a liquid conduit therethrough; and
at least one moveable element slideably coupled to said housing via at least one coupling;
said coupling including at least one pair of mutually magnetically interactive portions, one portion of said pair being located as at least part of said moveable element, the other portion of said pair at least partially formed as a buoyancy float in the liquid conduit wherein slideable movement of said moveable element produces a corresponding movement of said coupling portion within said housing; and wherein in use the position of the buoyancy float is variable by adjusting the total mass of at least one said moveable element.

2. A liquid apparatus as claimed in claim 1, wherein interaction between said portions of a pair of mutually magnetically interactive portions is by mutual magnetic attraction.

3. A liquid apparatus as claimed in claim 1, wherein interaction between said portions of a pair of mutually magnetically interactive portions is by mutual magnetic repulsion.

4. A liquid apparatus as claimed in claim 2, wherein said mutual magnetic attraction between the coupling portions is provided by:
a permanent magnet in one portion and a ferrous material or any other material capable of experiencing a motive force from a magnetic field (hereinafter termed a ‘magnetic material) in the other portion,
either an electromagnet or permanent magnet in both portions with magnetic polarity orientated for the portions to be mutually attractive; or
an electromagnet in one portion and a magnetic material in the other portion.

5. A liquid apparatus as claimed in claim 3, wherein said mutual magnetic repulsion between the coupling portions is provided by either an electromagnet or permanent magnet located in both portions of the coupling with a magnetic polarity orientated for the portions to be mutually repulsive.

6. A liquid apparatus as claimed in claim 5, wherein said apparatus is configured in use such that the portion of the coupling located in the moveable element is positioned at a higher elevation than the pair's corresponding portion in the housing.

7. (canceled)

8. A liquid apparatus as claimed in claim 1, wherein said slideable movement has an at least partially vertical component.

9. A liquid apparatus as claimed in claim 1, wherein said slideable movement is substantial linear about a vertical axis.

10. A liquid apparatus as claimed in claim 1, wherein said slideable movement is at least partially circuitous, and/or includes a lateral component.

11. A liquid apparatus as claimed in claim 1, wherein said housing includes a substantially vertical elongate tube with an inner and outer surface.

12. A liquid apparatus as claimed in claim 10, wherein the or each slideable element is located about said outer surface with said corresponding float located adjacent said inner surface.

13. A liquid apparatus as claimed in claim 10, wherein the inner tubular surface also defines said liquid conduit.

14. A liquid apparatus as claimed in claim 1, wherein the vertical height of the float and moveable element coupled to the float is controlled by at least one of:
adjusting the vertical height of a column of liquid in the liquid conduit, such that the float and moveable element is maintained at the liquid column's upper surface;
adjusting the flow rate of liquid flowing through the liquid conduit;
adjusting the total mass of a moveable element.

15. A liquid apparatus as claimed in claim 1, wherein allowable movement of the float is vertically constrained by an upper and lower stop in the liquid conduit.

16. A liquid apparatus as claimed in claim 1, wherein the moveable element includes a liquid discharge means.

17. A liquid apparatus as claimed in claim 1, further including a liquid supply, pump and liquid flow control system.

18. A liquid apparatus as claimed in claim 16, wherein the liquid flow control system incorporates user control.

19. A liquid apparatus as claimed in claim 1, wherein said moveable elements are selected from the group including; annular dish shapes with curved, circular, polygonal, asymmetrical, continuous or segmented portions.

20. A liquid apparatus as claimed in claim 1, wherein at least one said moveable element includes a liquid detention portion capable of receiving, and at least temporarily retaining, liquid.

21. A liquid apparatus as claimed in claim 1, wherein the or each moveable element includes liquid drain apertures.

22. A liquid apparatus as claimed in claim 19, wherein the or each moveable element includes liquid drain apertures, positioned to allow the egress of liquid collected in said liquid detention portion.

23. A liquid apparatus as claimed in claim 21 or 22, wherein said liquid drain apertures are reversibly sealable.

24. A liquid apparatus as claimed in claim 1, further including at least one of:
magnetic buffers replacing, or supplementing, the upper and lower stops defining maximum travel of the float and/or movable element;
supplementary, or alternative motive means to raise and lower the moveable element, acting on the float, moveable element or both;
forming the housing, float and/or the moveable element as translucent, transparent or opaque.

25. A liquid apparatus as claimed in claim 1, wherein said housing is formed as an elongated structure, at least partially encircled by said movable element.

26. A liquid assembly including two or more liquid apparatus' as claimed in claim 1.

27. A liquid assembly as claimed in claim 25 configured with at least two housings being spatially disposed such that their respective moveable elements interleave to allow liquid to interact therebetween.

28. A lift capable of moving a support surface between at least two platforms, the lift including
a liquid apparatus as claimed in claim 1, wherein an upper surface of said movable element provides said support surface for transportation of individuals and/or objects;
a liquid supply,
pump, and
liquid flow control system,
wherein the liquid flow control system is user-controllable to effect movement of the support surface between said platforms.

29. A method of operating a liquid apparatus as claimed in claim 1, said method including the steps of:
filling the liquid conduit with fluid until the float and moveable element rise to an upper stop;
increasing the moveable element mass by ingress of, and at least partial retention of, liquid until the combined liquid and moveable element mass exceeds buoyancy of the float and the coupled float and moveable element descend, and
discharging the retained liquid from the moveable element allowing the float and moveable element to float upwards.

30. The method as claimed in claim 29, wherein said ingress of liquid into the moveable element is provided by liquid overflow from the liquid conduit.

31. The method as claimed in claim 29, wherein said ingress of liquid into the moveable element is supplied from an external liquid supply.

32. The method as claimed in claim 29, wherein liquid is pumped into the liquid conduit until liquid egresses from an outlet in the liquid conduit into the or each moveable element.

33. The method as claimed in claim 29, wherein said movable elements include at least one fixed, unsealed drain apertures and a liquid detention portion capable of receiving, and at least temporarily retaining, liquid, and when the moveable element is in an upper position resting against an upper stop, said method further includes the step of
vertically lowering the movable element by adjusting the liquid flow controller to a flow rate sufficient to cause the ingress of liquid into an element's detention portion to exceed the drainage rate from the drain apertures.

34. The method as claimed in claim 33, further including the step wherein the detention portion fluid ingress rate is adjusted to a value below the drainage rate, resulting in a net egress of liquid from the detention portion, causing the movable element to rise.

35. The method as claimed in claim 29, including the steps of:
a user at a first platform moves onto a substantially adjacent movable element causing user and movable element to descend;
the user exits the apparatus at a lower second platform,
the movable element rises back to the first platform.

36. The method as claimed in claim 35, including the steps of: decreasing the rate of descent by friction breaking effected by portions of a users' body placed in pressure contact with said housing during said descent.

37. (canceled)

38. (canceled)

39. (canceled)

40. A liquid apparatus as claimed in claim 1 wherein said total mass is adjustable by addition or removal of at least one of liquid and/or solid mass and/or living being to or from the movable element respect
